(19) United States
(12) Patent Application Publication
(10) Pub. No.: US 2006/0042114 A1
(43) Pub. Date: Mar. 2, 2006

(54) Travel clothes dryer

(76) Inventors: Matthew Robson, Staten Island, NY (US); Alan Wolf, New York, NY (US)

Correspondence Address: ALAN WOLF, THE COOPER UNION, 51 ASTOR PLACE, NEW YORK, NY, 10003, US

(21) Appl. No.: 10/926,723

(22) Filed: Aug. 26, 2004

(51) Int. Cl. F26B 19/00; F26B 25/00

(52) U.S. Cl. 34/90; 34/103

(57) ABSTRACT

A portable clothes dryer has a frame (10) comprising a spine (15) and clothing support arms (20). One or more frame components are electrically heated through the use of resistive heating elements (25). A hook (45) or other connector at the upper end of the dryer allows it to hang from a shower curtain rod or wall protuberance. For portability, one or more components of the frame either telescopically collapse or rotate into a more compact configuration. Clothing draped over the arms or enveloping the frame is locally heated, wicking moisture away from other parts of the clothing, facilitating the drying of the entire garment.

### CROSS-REFERENCE TO RELATED APPLICATIONS

Not applicable.

### BACKGROUND

1. Field of Invention

This invention relates to a clothes dryer, in which wet clothing is dried on a heated collapsible frame.

2. Description of Related Art

Often a traveler will wash or “rinse out” items of clothing in a hotel room in the evening, in the hope that these garments will dry by morning through the processes of dripping and evaporation. For short we refer to the combination of these two processes, at ambient temperature, as “drip-drying”. Small garments may easily be washed in a bathroom sink, but drying them presents a number of difficulties.

One approach is to wring out excess water by hand pressure and hang the damp clothing in the shower. The traveler is likely to find that the clothing is not dry by morning. Factors that can exacerbate this problem include high local humidity, the additional humidity of the bathroom, and the composition of the clothing (e.g., 100 percent cotton clothing is particularly slow to drip-dry). Furthermore, hanging these items in the shower interferes with the ordinary use of the shower. A second approach consists of waving a portable hair dryer over each garment. Hair dryers are noisy, consume large amounts of power, and produce dangerously high temperatures. Also, the traveler's arm is likely to tire during the lengthy period of time required by this approach A third approach is to use a hotel laundry service. Laundry services, when available, tend to be expensive. Furthermore, hotels generally require a full day to do laundry, so this approach doesn't work for the traveler who will spend a single night in the hotel.

A clothes dryer that can dry clothing overnight and fits into a suitcase solves the traveler's problem A number of devices claim to be effective portable clothes dryers. However, none of these devices are suitable for a modern traveler, particularly an individual traveling by air, who will generally be carrying one or two small pieces of luggage.

A first category of portable clothes dryers employ integral fans or blowers to dry clothing with heated air, or with air of ambient temperature. Examples of such devices can be found in U.S. Pat. No. 6,263,591 (La Porte), U.S. Pat. No. 5,528,840 (Pajak), U.S. Pat. No. 5,038,497 (Pelequin), U.S. Pat. No. 4,918,290 (DeMars), U.S. Pat. No. 3,939,574 (Garot), U.S. Pat. No. 3,739,492 (Brooks), U.S. Pat. No. 3,626,602 (Glowacki), U.S. Pat. No. 3,577,650 (Brahm), U.S. Pat. No. 3,432,939 (Eichholz), U.S. Pat. No. 3,280,477 (Rawlins), and U.S. Pat. No. 1,470,242 (Qvprtox) Devices employing an integral fan or blower are too large, heavy, and noisy for a traveler.

A second category of portable clothes dryers employs an external heating device such as a hair dryer to heat the air within a hollow structure such as a garment bag. Examples of such devices can be found in U.S. Pat. No. 5,996,249 (Manning), U.S. Pat. No. 5,829,162 (Pace), U.S. Pat. No. 5,642,572 (Manning), U.S. Pat. No. 4,592,497 (Georges), U.S. Pat. No. 4,572,364 (Jordan), and U.S. Pat. No. 4,035,927 (Spiegel). One drawback of such devices is the need to carry a hair dryer in one's luggage, in the event that the hotel fails to provide one. Also, hair dryers typically consume 1500 watts of power and, at 120 volts, draw more than 10 amps of current. This is not only environmentally irresponsible, but creates a risk of electrocution or fire, particularly in the presence of wet clothing or overloaded circuits. The reasonably prudent traveler would not leave such a device unattended, in which case he or she would be subject to an intolerably loud noise until the clothing was dry.

A third category of portable clothes dryers employ electrical resistance heating. The devices disclosed in U.S. Pat. No. 2,567,434 (Hoskings), U.S. Pat. No. 2,622,180 (Hodges), U.S. Pat. No. 5,548,100 (Miller), U.S. Pat. No. 6,153,862 (Job), and Reissue 32,616 (Graham) are large and do not collapse. U.S. Pat. No. 3,160,482 (Foote) discloses a clothes dryer with a removable base, but this degree of collapsibility is insufficient to allow for storage in a suitcase.

### SUMMARY

In accordance with the present invention, a clothes dryer includes a collapsible frame to support clothing and heating elements for heating the frame.

### OBJECTS AND ADVANTAGES

It is an object of the present invention to provide a collapsible clothes dryer which, in its collapsed state, may be placed in a suitcase. Further objects of the invention include providing a travel clothes dryer that is self-contained, lightweight, energy efficient, safe, and silent. More objects and advantages will become apparent from the following description and drawings.

### DRAWING FIGURES

FIG. 1 is a front elevation view of a clothes dryer in which both the spine and the clothing support arms collapse telescopically.

FIG. 2 is a front elevation view of a clothes dryer in which the clothing support arms rotate from a position generally perpendicular to the spine (when the dryer is in use) to a position generally parallel to the spine (when the dryer is stored).

FIGS. 3A and 3B are front elevation views of clothes dryers in which outer arm segments rotatably collapse towards inner arm segments.

FIG. 4 is a side elevation view of a clothes dryer in which multiple clothing support arms can fold up parallel to the spine without colliding with each other.

FIG. 5 is a front elevation view of a clothes dryer in which a lower spine section rotatably collapses towards an upper spine section.

FIG. 6 is a front elevation view of a clothes dryer in which both the spine and the arms collapse telescopically and connecting straps support the dryer.

FIGS. 7A and 7B are broken perspective views illustrating different ways of maintaining electrical contact between resistive heating elements located in the telescoping segments of a frame component.

### DETAILED DESCRIPTION OF INVENTION

A description will now be given of the invention with respect to the attached drawings. These drawings are exemplary in nature and in no way limit the scope of the invention, which is defined by the claims appearing herein below.

A clothes dryer possesses a frame for supporting clothing. Frame components include a spine and one or more clothing support arms (“arms”). Some or all of the frame components are electrically heated. Attached to the frame is a hook or other support which enables the dryer to hang from diverse objects, such as a shower curtain rod, a closet rod, or a coat hook. One or more frame components collapse so the dryer becomes small enough to pack inside luggage or to fit within a small space such as a dresser drawer.

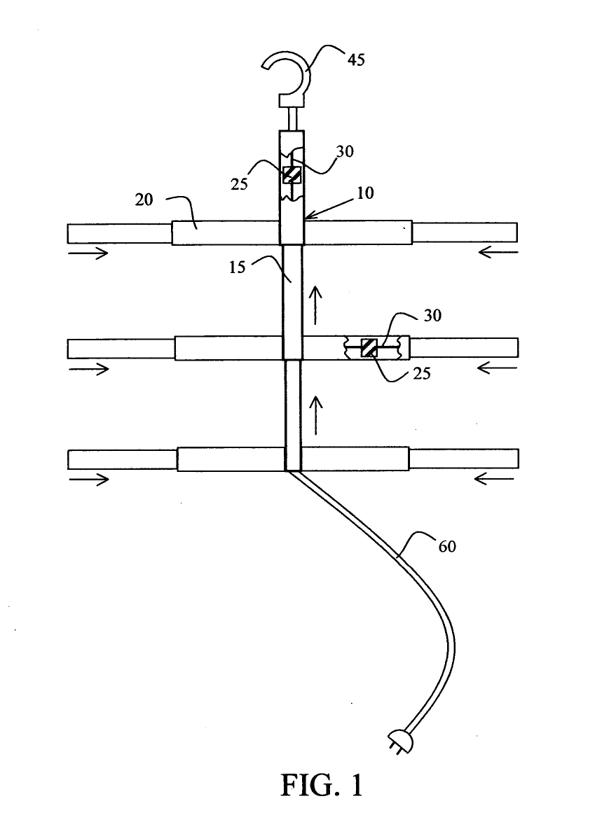

FIG. 1 shows an embodiment of a travel clothes dryer. A frame 10 includes a vertically disposed telescoping spine 15 and telescoping clothing support arms 20, upon which wet clothing can be draped. The arms are connected to the spine, spaced along its length, and project horizontally from the spine. Attached to the top of the frame is a hook 45 that is preferably rotatable about the axis of the spine. Frame components move as indicated by the arrows. Electrical wiring 30, appropriately tensioned and coiled, is centrally disposed within frame components and supplies heating elements 25 with electricity. The heating elements are permanently affixed to the inner surface of each frame component. An electric cord and plug 60 exit the spine at its tail end.

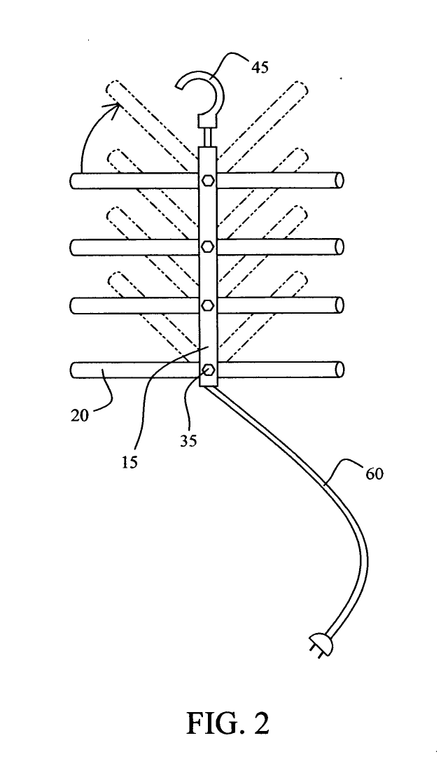

FIG. 2 shows an alternative embodiment, in which a compact form is achieved by means of a rotatable connector 35 that connects each arm to the spine. Arms rotate from a position generally perpendicular to the spine (when in use) to a position generally parallel to the spine (when stored), as shown by the arrow. Appropriate rotatable connections include pin joints, hinges, and the like.

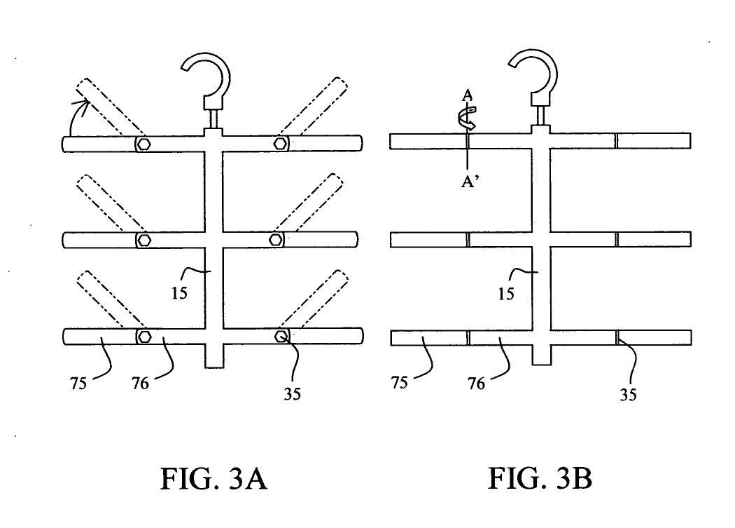

FIGS. 3A and 3B show embodiments in which each clothing support arm possesses and outer arm segment 75 connected by a rotational connector 35 to an inner arm segment 76. In FIG. 3A, to collapse the dryer for storage, the outer arm segments may be rotated, as shown by the arrow, by e.g., 90 degrees upward (parallel to the spine) or 180 degrees (to rest on top of the inner arm segments). While FIG. 3A illustrates a two segment arm, the concept embraces arms with three or more segments. In FIG. 3B, the dryer collapses for storage when the outer arm segments are rotated around the axis A-A′ until they rest on top of the inner arm segments, as shown by the arrow.

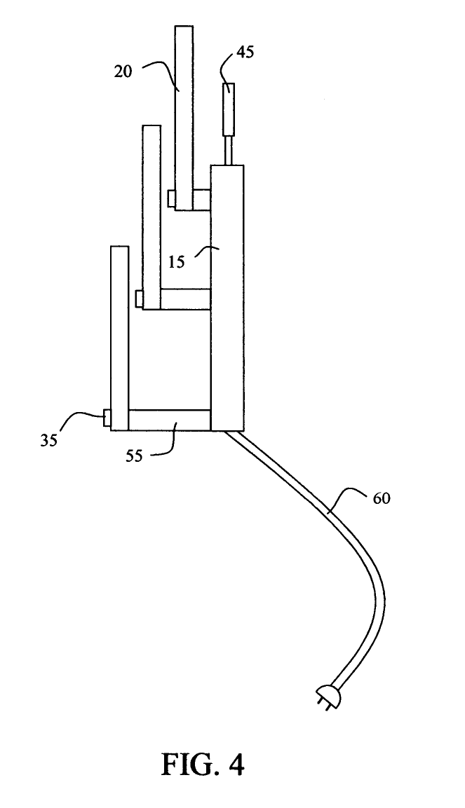

FIG. 4 illustrates one way in which rotatable frame components (here arms 20, connected to the spine 15 with connectors 35) can fold parallel to other frame components (here the spine) without colliding with each other. Spacers 55, whose size is exaggerated in this figure, provide a horizontal offset between adjacent arms.

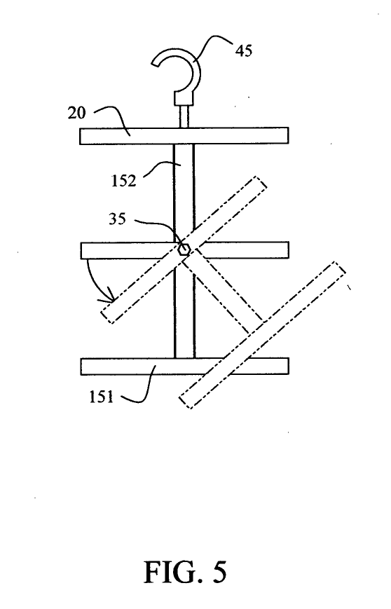

FIG. 5 shows an embodiment utilizing a rotatable connector 35 that connects an upper spine section 152 and a lower spine section 151. For purposes of compact storage the lower section is able to rotate upward, as indicated by the arrow, by e.g., 180 degrees.

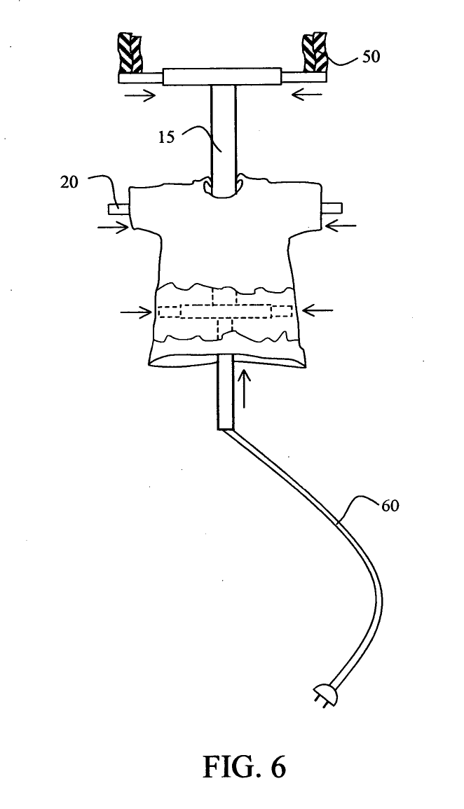

FIG. 6 shows the use of a pair of connecting straps 50, rather than a hook, as a means of hanging the frame. The straps allow the dryer to hang from a shower curtain rod, closet rod, or other wall protuberance. The gap between the connecting straps permits, e.g., a pair of pants (not shown) to be draped across the uppermost clothing support arm. Connecting straps may employ, for example, hook and loop type fasteners, straps connected by a buckle, or cloth tie strings. FIG. 6 also illustrates how the use of telescoping arms, whose motion is indicated by arrows, makes it easier to load and/or dry certain items of clothing of varying width, such as a polo shirt, with the arms partially collapsed.

In operation, the dryer works as follows. Clothing to be dried is draped over one or more frame components. Small garments, such as socks, may be slid over a single arm, while a larger garment such as a shirt or a jacket may envelop most or all of the frame. Heated frame components produce local drying of garments which causes moisture to wick from the remaining wet portions of the garment. The combination of wicking and local heating causes garments to dry faster than if they were simply drip-dried. In a typical embodiment, the power consumption of the clothes dryer will be less than 200 watts and the surface temperature of frame components will reach approximately 160° F.

The rate at which garments will dry depends on the condition of the garments (wetness, thickness, fabric type) as well as numerous design parameters, such as the number of arms, the cross-sectional shape and size of each arm, the choice of a heated or unheated spine, and the selected wattage of the electric heating elements. In our experimental work with a 200 watt prototype, the rate at which clothing dried (measured in grams of water weight lost per minute) was two to three times greater than the drip-drying rate. Wrinkling of garments, such as shirts, pants, and jackets is minimized because the shape of the garment when draped over the frame is similar to its shape when worm.

Frame components may be made from any strong, lightweight material, such as certain plastics or metals that can withstand temperatures of; for example, 200° F. Metal frame components are preferred for their high thermal conductivity. Tubular frame components will typically be circular or rectangular in cross-section. The use of hollow frame components reduces the weight of the dryer and provides a protective channel for insulated electrical wiring and heating elements.

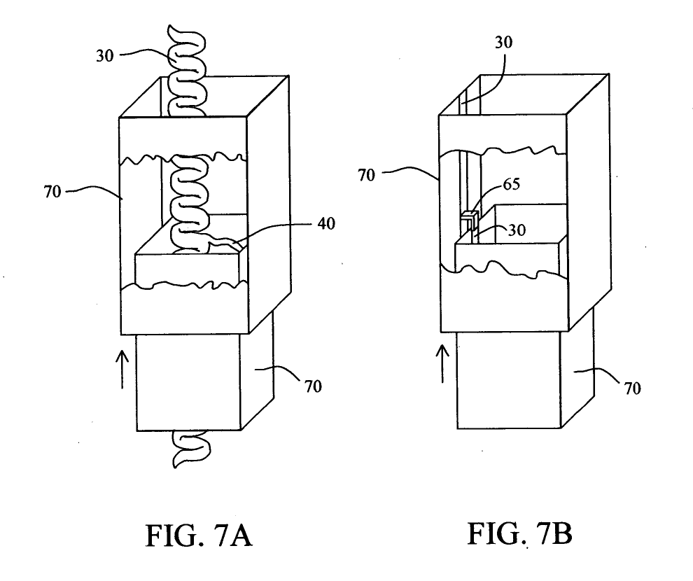

When rotatable frame structures are used, as in FIG. 2, the electrical wiring contained with the frame components only needs to be sufficiently flexible to move through an angle of, for example, 90 degrees. Where telescoping frame structures are used, conventional wiring may tend to pinch, snag, or tear between approaching or receding sections of the telescoping component. One way to avoid such problems is shown in FIG. 7A. Insulated coiled two-conductor wiring 30 fits within the hollow telescoping frame segments 70. With the appropriate tensioning of the coiled wiring there will be insufficient slack, even in the fully collapsed configuration, for the wiring to be pinched between adjacent telescoping segments. Within each telescoping segment one or more branch-off wires 40 connect the coiled wiring to one or more heating elements (not shown). Branch-off wires in all but the bottommost segment attach to the segment at or near the upper end of the segment. This avoids interference from the segment below when it collapses upward, as indicated by the arrow. As no segment telescopes upwards into the interior of the bottommost segment, branch-off wires may be attached anywhere along its inner surface.

There are numerous additional ways of avoiding the problem of pinched or stretched wiring within telescoping frame components. One approach involves the use of a spring-loaded “take-up reel” which gathers or releases insulated wiring as the frame component is collapsed or extended. Another approach, shown in FIG. 7B, employs insulated electrical wiring 30 laminated or otherwise affixed to the inner surface of the telescopic frame component 70. A metal brush 65 maintains electrical contact between adjacent sections. In such embodiments, heating elements may be soldered or otherwise permanently affixed directly to the laminated wiring.

The heating of frame components may be achieved by any electric heating element. These elements may be located, e.g., within hollow frame components or on the outer surface of frame components. Appropriate heating elements are widely used in therapeutic electric heating pads, electric blankets, and radiant floor heating systems. Such heating elements include, but are not limited to, flexible film heaters and conventional insulated resistive wire. Resistive heating elements perform identically for 50-cycle and 60-cycle current, but dissipate four times as much energy at 240 volts as compared to 120 volts. The addition of a step-up or step-down transformer allows the dryer to be used internationally.

Many additional embodiments are possible, including all combinations of telescopically and rotatably collapsing frame elements, and such diverse hanging means as a single hook, multiple hooks, a single strap, multiple straps, and the like. Factors such as the length of the spine and arms, the number and spacing of the arms, and the angle of the arms relative to the spine in the “open” configuration, may be freely varied. Similarly, the spine may be located at or near the right or left side of the frame, rather than running down the center of the frame. Such embodiments will more easily accommodate large items such as pants and towels. Finally, we have shown a spine that runs the full length of the dryer; however there are other embodiments in which the spine is vestigial or consists of distributed components.

### CONCLUSION

Accordingly, the reader will see that we have disclosed a clothes dryer which is compact, lightweight, energy efficient, safe, and silent, and is therefore suitable for a traveler, a dorm room, or under any circumstances in which a compact dryer would be desirable.

Although the description above contains some specificities, these should not be construed as limiting the scope of the invention but as merely providing illustrations of some of the presently preferred embodiments of this invention. For example, the words “parallel” and “perpendicular” have been used to describe the orientation of the clothing support arms relative to the spine. These terms are used only to suggest an approximate relative orientation, rather than specific angles such as 0 degrees and 90 degrees. An angle of, e.g., 85 degrees may be preferable to one of 90 degrees, as a slight upward inclination of the arms would reduce the likelihood that garments will fall off the dryer. Similarly, an angle of, e.g., 5 degrees may be preferable to one of 0 degrees, as the arms might not be able to collapse strictly parallel to the spine in certain embodiments. Thus the scope of the invention should be determined by the appended claims and their legal equivalents, rather than by the examples given.

1. A travel clothes dryer comprising:
(a) a telescopically collapsing spine;
(b) one or more telescopically collapsing clothing support arms attached to the spine;
(c) electric heating elements disposed within the spine and clothing support arms; and
(d) a hook attached to the upper end of the spine.

2. A travel clothes dryer comprising:
(a) a collapsible frame adapted to support clothing;
(b) an integral heating element for heating said frame;
(c) wherein said frame conductively heats the clothing.

3. The travel clothes dryer of claim 2 wherein the collapsible frame comprises one or more collapsible arms attached to a collapsible spine.

4. The travel clothes dryer of claim 3 wherein the arms and spine collapse telescopically.

5. The travel clothes dryer of claim 3 wherein the arms are pivotally attached to the spine, and rotate from a position generally parallel to said spine, to a position generally perpendicular to said spine, and said spine collapses by rotatably folding upon itself

6. The travel clothes dryer of claim 3 wherein the arms collapse telescopically and the spine collapses by rotatably folding upon itself.

7. The travel clothes dryer of claim 3 wherein the arms are pivotally attached to the spine, and rotate from a position generally parallel to said spine, to a position generally perpendicular to said spine, and the spine collapses telescopically.

8. The travel clothes dryer of claim 3 wherein the collapsible arms comprise two or more segments pivotally attached to each other.

9. The travel clothes dryer of claim 2 wherein the collapsible frame comprises one or more arms attached to a collapsible spine.

10. The travel clothes dryer of claim 9 wherein the spine collapses telescopically.

11. The travel clothes dryer of claim 9 wherein the spine collapses by rotatably folding upon itself.

12. The travel clothes dryer of claim 2 wherein the collapsible frame comprises a spine attached to one or more collapsible arms.

13. The travel clothes dryer of claim 12 wherein the arms collapse telescopically.

14. The travel clothes dryer of claim 12 wherein the arms rotatably collapse through a pivotal connection to the spine.

15. The travel clothes dryer of claim 12 wherein the arms comprise two or more segments pivotally attached to each other.

16. A travel clothes dryer comprising:
(a) means for supporting clothing;
(b) means for collapsing said clothing supporting means; and
(c) a heating element to heat said clothing supporting means and conductively heat the clothing.

17. A travel clothes dryer of any one of claims 2 through 16, further comprising means for hanging said clothes dryer.
